(19) United States
(12) Patent Application Publication
(10) Pub. No.: US 2009/0249468 A1
(43) Pub. Date: Oct. 1, 2009

(54) Method for establishing distributed filters in a packet-oriented network, based on abstract security defaults

(75) Inventors: Joachim Charzinski, München (DE); Birger Toedtmann, Duisburg (DE)

Correspondence Address: Dickinson Wright, PLLC, 1875 Eye Street, NW, Suite 1200, Washington, DC, 20006, US

(73) Assignee: Nokia Siemens Networks GmbH & Co. KG, Munich (DE)

(21) Appl. No.: 11/795,046

(22) PCT Filed: Jan. 5, 2006
(86) PCT No.: PCT/EP2006/050053

§ 371 Date: Aug. 19, 2008

(30) Foreign Application Priority Data
Jan. 10, 2005 (DE) 10 2005 001 150.0

(51) Int. Cl. G06F 21/00

(52) U.S. Cl. 726/13

(57) ABSTRACT

A method for a packet-oriented network is provided. According to the method, after analysis of the network configuration and the existing network elements, the implementation of predefined security guidelines is automatically mapped onto the options of the different network elements and the distribution of the various security functions in the different network elements is optimized in such a way that the protection target is achieved, no network element receives too many configuration entries and no redundant functions are implemented.

The subject matter of the application relates to an automated development and use of efficiently distributed filters in packet-oriented heterogeneous networks

The subject matter of the application relates to a method for establishing distributed filters in a packet-oriented network based on security defaults with the features of claim 1.

In packet-oriented networks (e.g. Ethernet networks or IP networks), which are connected to further networks, protection mechanisms must be used to
protect the end customer of the networks against attacks (e.g. viruses, worms, intrusion attempts, Distributed Denial of Service (D)Dos) via the network
to protect the network elements against attacks.

To this end, what are referred to as firewalls are used at selected points of the network, but packets filters are also configured in routers, service servers (e.g. Softswitch) or Ethernet switches (also Digital Subscriber Line Access Module DSLAM). The configurations of all these filters are to be aligned to one another so that
no network element remains unprotected, i.e. the protection target is actually achieved
the misconfiguration of a network element can not be used to bypass the filters of other network elements
filters in a heterogeneous network are configured on those network elements which can support the corresponding functions
no more filters are to be configured in a network element than can be supported (either due to fixed limits, e.g. of table or list variables, or for performance reasons)
no redundant or multiple functions are provided unnecessarily

The alignment of the configurations, the creation of the respective configuration files and the implementation of the configurations are nowadays carried out manually. Management systems exist, which offer a coordinated configuration for a class of network elements (e.g. for the firewalls of a manufacturer in a network).

The problem underlying the subject matter of the application is one of creating a system, which effects a coordinated configuration for a number of classes of network elements, for the elements of different manufacturers and with automatic optimization of the distribution of functions.

The problem is resolved by the features of claim 1.

The network operator need not produce any protracted and error-prone configurations of security functions manually. He/she need not attempt to appropriately distribute the functions on the network elements manually.

Advantageous developments of the subject matter of the application are specified in the subclaims.

The subject matter of the application is described in more detail below, as an exemplary embodiment on a scale required for understanding, with reference to the figures, in which;

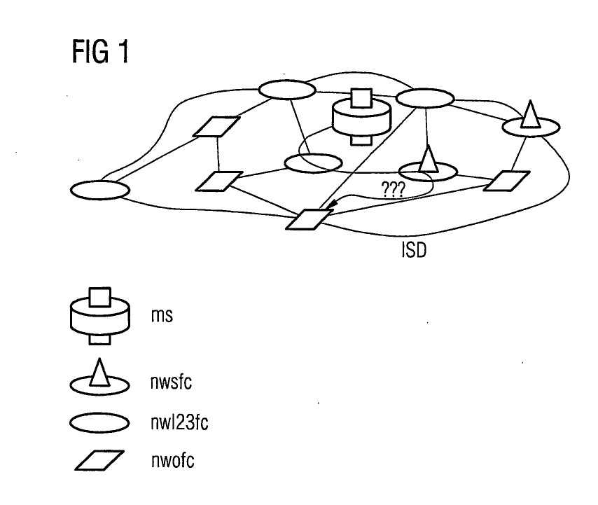

FIG. 1 shows an inventive arrangement for establishing an access security default and

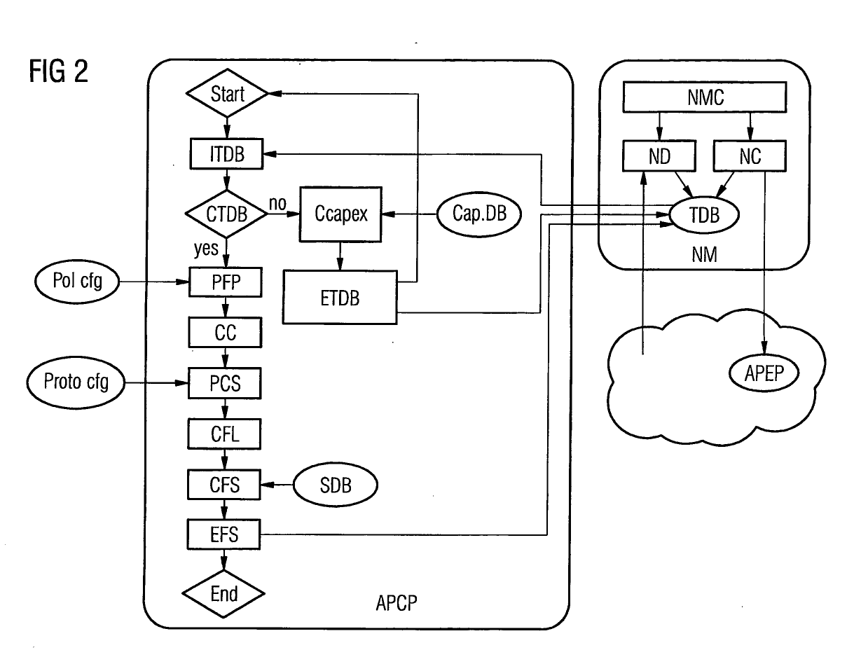

FIG. 2 shows an implementation of the arrangement for establishing an access security default in a network.

FIG. 2 shows a schematic illustration of a network formed with nodes/network elements, said network comprising a management system. The network elements can differ according to the hardware platform, operating system, installed filters/installed filter software and also according to the installed version of software, whereby the network comprises a heterogeneous structure.

FIG. 1 shows a basic arrangement for the interaction of a network, which comprises an access policy enforcement point (APEP), having a network management facility NM and an access policy configuration point (APCP). Upon control of a network management control (NMC), a network discovery (ND) analyses the structure of the network and transfers the results into a topology database TDB. In the access policy configuration point, the data from the topology database of the network management is made available at the start in the action point ITDB (import technology data base). In the decision point CTDB (capabilities in topology data base), a query is made as to whether, for the individual network elements, the abilities of their security measures are stored.

If the query in the decision point CTDB is positive (yes), a formal formulation of these guidelines is produced in the action point PFP (path filter policy) taking into consideration a security guideline Polcfg (policy configuration) supplied externally. In the action field CC (call classifier), a list of the relevant network elements is prepared as applicable to the further processing in consideration of the present access specification. By way of example, the function call classifier provides a set of IP addresses and interface names to the assignment specification “all routers”, with the function querying the topology database in order to obtain the necessary IP addresses. By way of example, the specification “all routers and management servers” translates into 10.0.0/8 and 10.1.1. In this way, the prefixes are advantageously aggregated in order to achieve a detailed description for “all routers”. In the action point PPS (path protocol specification), the protocol specification database Protocfg is queried in order to obtain a valid expression for statements such as “via management protocol”, this being an invariant specification which must be substantiated according to the protocol used. In the action field CFL (computed filter location), the best filter positions which are suited to a specific packet flow are determined. Since the paths, by way of which the access-controlled packet flows run, can change with the change in the network-internal routing, the CFL considers several paths and adds additional filters to additional nodes. The filter positioning function may provide an estimation relating to the security characteristics of the proposed configuration and furthermore an assessment as to how these characteristics change in the event of a change in the routing. In the action point filter syntax determination CFS (compute filter syntax), the correct syntax specification for the platform and the operating system of the individual nodes, where the filters are arranged, is determined with the aid of a syntax database SDB (syntax data base), in order to convert the hitherto incomplete filter statements into real, functional filter rules. To this end, XML stylesheet formatting can be advantageously used for the conversion to syntactically correct rules. In the action point EFS (export filter statement), the syntactically correct filter rules are provided in the topology database of the network management, from where they are routed via a node configuration facility NC (node configurator) to the respective nodes, where the filter rules are implemented.

The system according to the invention allows security guidelines to be predetermined to a network operator in an abstract formulation and the system then
after analysis of a network configuration and the existing network elements
automatically maps the implementation of these security guidelines onto the options of the different network elements
optimizes the distribution of the various security functions in the different network elements in such a way that (1) the protection target is achieved, (2) no network element receives too many configuration entries and (3) no redundant functions are implemented.

The system receives a network description (topology, addresses, network elements) from a network management system NM for instance. In addition, a mapping specification is required, which generally specifies which functions support which network element (e.g. packet filter, stateful firewall, filtering on MAC address level). In addition, the system contains mapping specifications for the configuration of functions for network elements in the respective configuration language (e.g. command line interface CLI for different network elements such as Cisco routers, Juniper M/T, Juniper E, Ethernet switch by Siemens, Firewall by Checkpoint, etc.).

In a first step from the abstract formulation of the security guidelines, the system produces (if necessary) a formal formulation of these guidelines, and then optimizes the distribution of the functions onto the network elements and finally generates a configuration file for each network element in its configuration language.

Options and Enhancements
a. Specification of a classification of the network elements with priorities, as to which types of functions are preferably to be carried out in which type of network elements
b. Specification of a mapping function, which, with regard to a target function of an optimization, specifies a quality as a function of the relative filling of filter tables in respect of their limits and/or as a function of the number of filter operations or rules.
c. Automatic calculation of a quality function for evaluating the level of achievement of the protection target on the basis of the generated configurations
d. Use of the quality function of option c as a target function of an optimization
e. Automatic configuration by the system or by a connected network management system
f. Option of occasionally deactivating a component of the security guidelines in a targeted manner and automatically producing the corresponding configuration commands
g. Specification of an existing configuration with the proviso of carrying out the protection target with as few changes as possible compared with existing configurations
h. Combining the system with a system for automatically generating an address plan
i. Use of the system for optimized positioning of firewall systems for instance (network planning for the provision of security functions)
j. Use of the system in a network, in which only Ethernet switches or only IP routers are to be configured
k. Combining with a system for automated formal verification of the configuration in respect of the predefined security guidelines.
l. Realization of options c and d by a mechanism, which combines all conceivable paths on the basis of the topology and evaluates the quality of the solution for all possible combinations of filters according to the capabilities of the network elements on this path
m. Realization of option 1 with suitable heuristics for limiting the solution space.

1.-17. (canceled)

18. A method for establishing distributed filters in a packet-oriented network based on security defaults, comprising:
selecting a relevant network element of the network according to a formal formulation security default;
providing a security characteristic of the network elements;
locating a network element which effect a conversion of the security default for a packet flow; and
activating in the located network element a filter corresponding to the security default.

19. The method as claimed in claim 18, wherein the filter is activated by generating a configuration file in a configuration language used by the network element.

20. The method as claimed in claim 18, wherein a level of security offered by the filter is gradually reduced until the security default is still adhered to.

21. The method as claimed in claim 18, wherein the formal formulation of the security default is derived from an abstract formulation of the security default.

22. The method as claimed in claim 18, further comprising specifying a classification of each network element with a priority as to which type of function is to be implemented in which type of network element.

23. The method as claimed in claim 18, wherein a mapping function, which, with regard to a target function of an optimization, specifies a quality as a function of the relative filling of filter tables in respect of their limits and/or as a function of the number of filter operations or rules.

24. The method as claimed in claim 18, further comprising automatically calculating a quality function for evaluating a level of achievement of the security default on the basis of the generated configuration.

25. The method as claimed in claim 24, wherein the quality function is used as a target function of an optimization.

26. The method as claimed in claim 24, wherein the automatic configuration is by the network management system.

27. The method as claimed in claim 18, further comprising deactivating a component of the security default in order to automatically generate a corresponding configuration command.

28. The method as claimed in claim 18, wherein specifying an existing configuration with the proviso of carrying out the security defaults with minimal changes compared with the existing configuration.

29. The method as claimed in claim 18, wherein it interacts with a system for automatically generating an address plan.

30. The method as claimed in claim 18, wherein a firewall system is positioned.

31. The method as claimed in claim 18, wherein the network formed using only Ethernet switches.

32. The method as claimed in claim 18, wherein the network formed using only IP routers.

33. The method as claimed in claim 18, further comprising interacting with a system for automatically verifying the configuration in respect of the predetermined security default.

34. The method as claimed in claim 18, wherein all possible paths are combined for a packet flow on the basis of the network topology and the quality of the security defaults is determined for all possible combinations of filters according to the capabilities of the network elements for this path.
